(19) United States
(12) Patent Application Publication
(10) Pub. No.: US 2005/0005489 A1
(43) Pub. Date: Jan. 13, 2005

(54) Image display device and method

(75) Inventors: Ralph G. Ridenour, Mansfield, OH (US); Phillip P. McFadden, Mansfield, OH (US)

Correspondence Address: WALKER & JOCKE, L.P.A., 231 SOUTH BROADWAY STREET, MEDINA, OH, 44256, US

(73) Assignee: Universal Enterprises, Inc., Mansfield, OH (US)

(21) Appl. No.: 10/795,141

(22) Filed: Mar. 5, 2004

Related U.S. Application Data
(60) Provisional application No. 60/451,967, filed on Mar. 5, 2003.

(51) Int. Cl. G09F 7/04; G09F 13/00

(52) U.S. Cl. 40/600; 40/553

(57) ABSTRACT

A method of installing an image display device is provided. The method includes providing at least one image medium. The image medium includes at least one magnetic strip which extends in a loop about the perimeter of the image medium adjacent each edge of the image medium. The method further includes placing the image medium adjacent portions of runners of a suspended ceiling grid which form a rectangular opening beneath a ceiling light fixture. In addition the method includes magnetically adhering the at least one magnetic strip to the portions of the runners, whereby light from the ceiling light fixture is operative to illuminate the image medium.

### CROSS REFERENCE TO RELATED APPLICATIONS

This application claims benefit of U.S. Provisional Application Ser. No. 60/451,967 filed Mar. 5, 2003.

### TECHNICAL FIELD

This invention relates to image display devices. Specifically this invention relates to a new apparatus and method for illuminating images.

### BACKGROUND ART

Photographs are a well-known means for depicting objects, people, and places. Various apparatus and methods exist to display photographs. For example photographs may be displayed in frames mounted on a wall. Photographs may also be compiled into photo albums. In addition photographs may be digitally scanned and shown on a computer screen or other monitor. Each of these methods for displaying images offers a different and visually appealing way to display images for people to enjoy. As individuals and businesses wish to find new and original ways to present images, there exists an ongoing need for discovering new and visually appealing devices and methods for displaying images including photographs, artwork, printed materials, or any other type of image which is intended to be optically viewed.

### DISCLOSURE OF INVENTION

It is an object of an exemplary form of the present invention to provide devices and methods for displaying images.

It is a further object of an exemplary form of the present invention to provide devices and methods for displaying images such as photographs.

It is a further object of an exemplary form of the present invention to provide devices and methods for displaying images such as printed works.

Further objects of exemplary forms of the present invention will be made apparent in the following Best Modes for Carrying Out Invention and the appended claims.

The foregoing objects may be accomplished in an exemplary embodiment by an image display device that is operative to illuminate an image medium. In an exemplary embodiment, the device is operative to enable light to be transmitted through an image medium. The device may include a support structure which is adapted to mount the image medium adjacent a light source. In the exemplary embodiment, the device may include the light source. On other exemplary embodiments, the device may be adapted to releasably mount an image medium adjacent an existing light source.

In an exemplary embodiment the image media may include a transparency medium such as Kodak Duratrans™ or Fuji Fujitrans®. Pictures may be placed on the transparency medium using a photography and developing process. In other exemplary embodiments the image medium may include white photography paper which has translucent qualities that permit light from the light source of the device to pass therethrough. In addition, in further exemplary embodiments, the image medium may include transparency sheets, paper or other transparent or translucent medium that is operative to permit pictures to be printed thereon by a printer or other device. As used herein the image media may include any medium that is operative to permit light to pass therethrough to illuminate at least a portion of a picture thereon. In an exemplary embodiment, the portions of the image medium that hold darker colored or black areas of a picture may be operative to transmit no light or relatively less light than portions of the image medium that hold lighter colored or whiter areas of a picture.

In one exemplary embodiment the device may include a clear transparent cylindrical tube that is operative to receive an image medium therein adjacent the curved inner surface of the tube. In an exemplary embodiment the device may include a light source located inside the tube which is operative to transmit light through the image medium and tube. Such a light source may include an adjustable base which is operative to enable a user to selectively adjust the position of the light source along the longitudinal axis of the tube.

In an exemplary embodiment the device may include a plurality of decorative platters positioned on the base and cover of the device which form a stepped contour. The platters may be in releasable connection with the device and with each other, such that one or more of the platters may be swapped out with different platters to enable the device to have different visual appearances. For example the platters may have different colors. To give the device a different appearance, one or more of the platters of one color may be swapped out with platters with a different color. Further one or more of the platters may include transparent and/or translucent portions. In exemplary embodiments, the device may be operative to direct light from the light source to pass through the platters to enable them to glow or illuminate.

In a further exemplary embodiment, the cover may include a centrally located handle. Such a handle may include a clear transparent or hollow pin portion that passes through holes in the origins of the platters. When the cover is placed on the device, the longitudinal axis of the pin may coincide with a direction that light travels outwardly from the light source to enable light from the light source to pass through the pin and into the portions of the handle that are located above the platters. The upper portion of the handle may be generally wider than the pin portion. In an exemplary embodiment the upper portions of the handle may flare out to form a generally conical shape. Light from the light source is operative to cause the handle to illuminate to give the device a distinctive look.

In this described exemplary embodiment, rectangular photographs or other image mediums may be operative to curl into a cylindrical shape which has a diameter which about corresponds to the inner diameter of the tube. The image medium may then be inserted into the tube such that the image medium angularly extends within the tube for about 360 degrees around the light source.

In an alternative exemplary embodiment, the device may include a support structure which is operative to display a rectangular image medium in a semicircle or arc. The device may include a light source located about the origin of the semicircle which is operative to transmit light through the image medium. In this described exemplary embodiment, the device may include a clear rectangular transparent sheet of about the same size and shape as the image medium. The device may be operative to outwardly bow both the transparent sheet and the image medium.

In this described exemplary embodiment, a back wall of the device may include support members which serve as brackets for releasably holding the side edges of the image medium and the transparent sheet. The support members may be operative to hold the side edges of the image medium at inwardly directed angles to enable an individual viewing the image medium from the front of the device to more easily see both the left-hand and right-hand sides of the image medium. In an exemplary embodiment, the support members may correspond to angled slots for receiving the side edges of the image medium. In other exemplary embodiments, the support members may include angled inner surfaces which are operative to hold the side edges of the image mediums in a bowed, arched, or semicircular shape.

In a further exemplary embodiment, an image display device may be operative to mount an image medium adjacent a light source. In this described exemplary embodiment, the image medium may have a size and shape which about corresponds to the dimensions of a standard sized suspended ceiling tile and/or fluorescent ceiling light fixture. For example, in the U.S. fluorescent ceiling lights may have a size and shape of about 2 feet by 4 feet to correspond to standard 2 feet by 4 feet ceiling tiles. Such lights or tiles are often supported by a metallic grid that is suspended from the ceiling. Such a grid may include a plurality of main runners and cross tees which form rectangular openings corresponding to the ceiling tile size. In an exemplary embodiment, the image medium may be adapted to mount to the main runners and cross tees of the suspended ceiling grid. Light from a fluorescent ceiling fixture positioned above the grid may be operative to illuminate the image medium. As used herein the portions of the main runners and cross tees which bound a rectangular opening for receiving a ceiling tile or light fixture are referred to herein as runners.

In one exemplary embodiment, the image medium may include flexible magnetic strips adhesively mounted to the edges of the image medium. When placed against the runners surrounding the ceiling light fixture, the magnetic strips are orientated to magnetically adhere to the runners so as to support the image medium directly below the light fixture.

This described exemplary embodiment of the device may further include a method of installing the image medium adjacent the ceiling light. The method may include rolling the image medium around a cylindrical object. The side of the image medium which does not include the magnetic strips may be placed in contact with the cylindrical object when rolling the image medium. When rolled up in this manner an outer edge of the image medium will include one of the magnetic strips. The magnetic strip may be placed against a runner adjacent an end of a light fixture and the image medium may be unrolled from the cylindrical object. As the image medium is unrolled, the magnetic strips at the edged of the image medium will uncurl and will magnetically adhere to the other runners of the grid which bound the ceiling light fixture.

In an exemplary embodiment, the cylindrical object may be rotationally mounted to at least one handle extending from at least one end of the cylindrical object. The handle may extend in a radial direction with respect to the cylindrical object to enable a user to more easily unroll the image medium adjacent a ceiling light fixture. In an alternative exemplary embodiment the handle may extend for many feet to enable a user to mount the image display device to a ceiling light fixture while standing on the floor.

### BRIEF DESCRIPTION OF DRAWINGS

FIG. 1 is a perspective view representative of an exemplary embodiment of an image display device.

FIG. 2 is a side cross-sectional view of a cover for an exemplary embodiment of the image display device.

FIG. 3 is a side cross-sectional view of an adjustable bracket for an alternative exemplary embodiment of the image display device.

FIG. 4 is a perspective view of an alternative exemplary embodiment of an image display device.

FIG. 5 is a top cross-sectional view of the alternative exemplary embodiment of the image display device.

FIG. 6 is a cross-sectional view of a support member of the alternative exemplary embodiment of the image display device.

FIG. 7 is an alternative exemplary embodiment of a support member.

FIG. 8 is a top plan view of a further alternative exemplary embodiment of an image display device.

FIG. 9 is a perspective view of the further alternative exemplary embodiment of the image display device being mounted adjacent a ceiling light fixture.

FIG. 10 shows a top plan view of a corner of a further alternative exemplary embodiment of an image display device.

FIG. 11 is a side cross-sectional view of the further alternative exemplary embodiment of the image display device being mounted adjacent a ceiling light fixture.

FIG. 12 is a top plan view of an exemplary embodiment of a mounting device for the further alternative exemplary embodiment of the image display device.

FIG. 13 is a side cross-sectional view of a cover for an alternative exemplary embodiment of the image display device.

FIG. 14 shows a schematic view of an image display device that includes a media device.

FIGS. 15 and 16 show perspective views of alternative exemplary embodiments of image display devices which include a media device.

FIGS. 17-19 show alternative exemplary embodiments of image display devices.

FIG. 20 shows a ring with spokes for an alterative exemplary embodiment of an image display device.

### BEST MODES FOR CARRYING OUT INVENTION

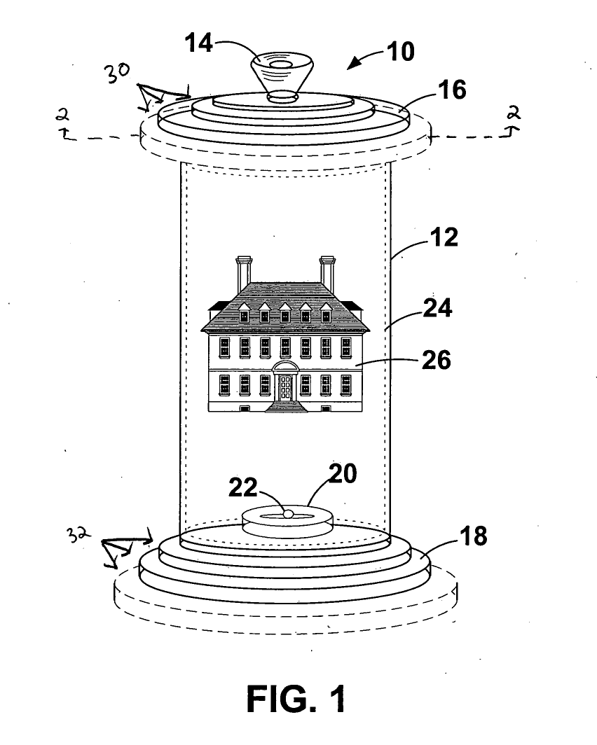

Referring now to the drawings and particularly to FIG. 1, there is shown therein a perspective view of an exemplary embodiment of an image display device 10. The device 10 may include a clear transparent member in the form of a clear transparent cylindrical tube 12. In this described exemplary embodiment the tube is comprised of a one-eighth inch clear acrylic. However, in alternative exemplary embodiments the tube may be made out of another plastic, glass or any other transparent material with sufficient thickness to maintain the shape of a cylinder. The exemplary embodiment of the device may further include a base 18 and a cover 16 located at opposed ends of the tube. The device may also include a light source 20 in operative connection with the base 18. The light source may include a halogen, incandescent, fluorescent or other type of bulb 22 which is operative to transmit light out of the device through the tube.

In the exemplary embodiment, the cover 16 and/or the base may be in removable connection with the tube to enable a user to insert an image medium 24 into the tube 12. Such an image medium may be curled into a cylindrical shape for placement adjacent the inside surface of the tube 12. In the exemplary embodiment the image medium may correspond to a developed photograph or a printed article with a picture 26 thereon. Portions of the image medium 24 may be sufficiently transparent and/or translucent to enable at least a portion of the light from the light source to pass therethrough. In an exemplary embodiment the image medium 24 may correspond to a transparency medium with the picture 26 developed thereon. Such a transparency medium may include Kodak Duratrans™ or Fuji Fujitrans®. However, it is to be understood that alternative exemplary embodiments may use other transparent and/or translucent medium for the image medium. For example, picturers developed on white photography paper may be used. Also transparency sheets or paper for use with ink jet, die sublimation, thermal wax transfer, laser or other printers may be used for the image medium. With each of these image mediums, at least a portion of the pictures formed on the image medium must be capable of transmitting light therethrough from the light source of the image display device. As used herein and in the claims, the word transparent includes both clear and non-clear or translucent properties of a material that is operative to enable light to pass therethrough.

In the exemplary embodiment, the base 18 and/or cover 16 may be comprised of two or more differently sized circular platters 30, 32. The circular platters may be placed one on top of the other from largest diameter to smallest diameter to form a stepped contour with radially inwardly directed consecutive steps. The platters may be comprised of an acrylic or other material and may be either transparent or opaque. The platters may also have the same color or different colors. One or more of the transparent platters may also be oriented to receive light from the light source therethrough so that the platters will illuminate or glow when the light source is turned on. In other exemplary embodiments the platters may be comprised of PVC or other thermoplastic, wood, metal or any other material which can be used to form a stepped contour for the base and/or cover of the image display device. In further exemplary embodiments, the platters and/or other components of the device may be comprised of fire resistant materials which do not support combustion and/or are self extinguishing.

For example the platters or other components of the image display devices described herein may be comprised of SINTRA® plastic manufactured by Alacan Composites USA, INC or other PVC or thermoplastic materials which may have fire resistant characteristics.

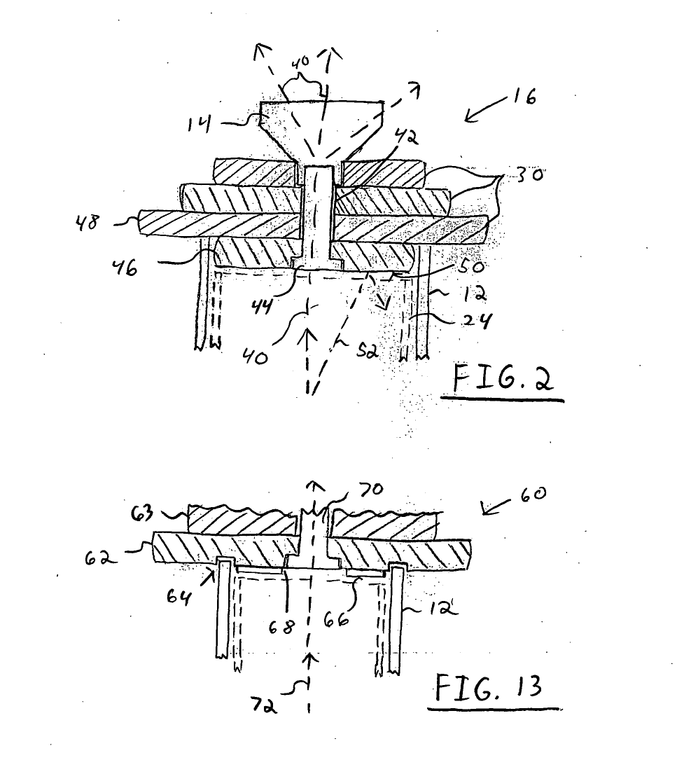

In the exemplary embodiment, the cover 16 may include a handle 14. The handle may be comprised of a clear acrylic or other transparent and/or translucent material. As shown in FIG. 2, the cover 16 may be operative to direct light 40 from the light source to transmit through the handle. As a result the handle is operative to illuminate or glow when the light source is turned on. In this described exemplary embodiment, the platters 30 may include an aperture 42 through the center of each platter. The cover may further include a transparent and/or translucent or hollow pin 44 which is operative to pass through the apertures 42 of the platters 30 and connect to the handle 14. In an exemplary embodiment the transparent and/or translucent pin may correspond to an acrylic bolt. The pin may be operative to fasten the platters and handle together to form the cover 16. In an exemplary embodiment, the pin 44 may be glued to the handle with an adhesive that dries clear. In other exemplary embodiments, the pin may include a threaded portion that is operative to thread into the handle, a platter and/or a nut adjacent the bottom of the cover.

In an exemplary embodiment, the cover 16 may include a lower platter 46 with a diameter that about corresponds to and/or is less than the inner diameter of the tube 12. The cover 16 may further include a relatively larger platter 48 above the lower platter 46. The larger platter may have a diameter that is larger than the inner diameter of the tube 12. In this described exemplary embodiment, when the cover 16 is placed on the tube 12, the lower platter 46 is inserted into the tube 12 and the relatively larger platter 48 rests on the top edge of the tube. In this described exemplary embodiment, the lower platter 46 may include a reflective surface 50 which is operative to reflect light 52 from the light source downwardly and outwardly through the image medium 24 and tube 12.

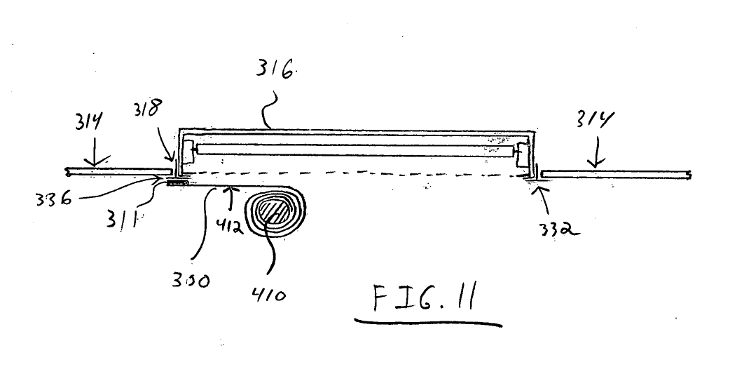

FIG. 13 shows an alternative exemplary embodiment of a cover 60 for the image display device. Here the cover includes a lower platter 62 with a diameter that is larger than the inner diameter of the tube 12. The lower platter 62 may also includes a circular groove 64 milled or molded, or otherwise formed therein. The groove may have a size and shape that is operative to receive the top edge of the tube 12 therein. In other exemplary embodiments the cover may include other features in the lower platters to prevent the cover from sliding off of the top of the tube 12. For example, rather than a groove 64, the lower platter 62 may correspond to a ring with a circular aperture therethrough. The tube 12 may pass through the aperture and contact the next platter 63. In these described exemplary embodiments, the lower surface of the lower platter 62 (or the second platter 63, in embodiments with a ring shaped lower platter) may include a circular reflective sheet 66 adhesively mounted thereto. The sheet may include an aperture 68 to enable light 72 from the light source to pass into a pin 70.

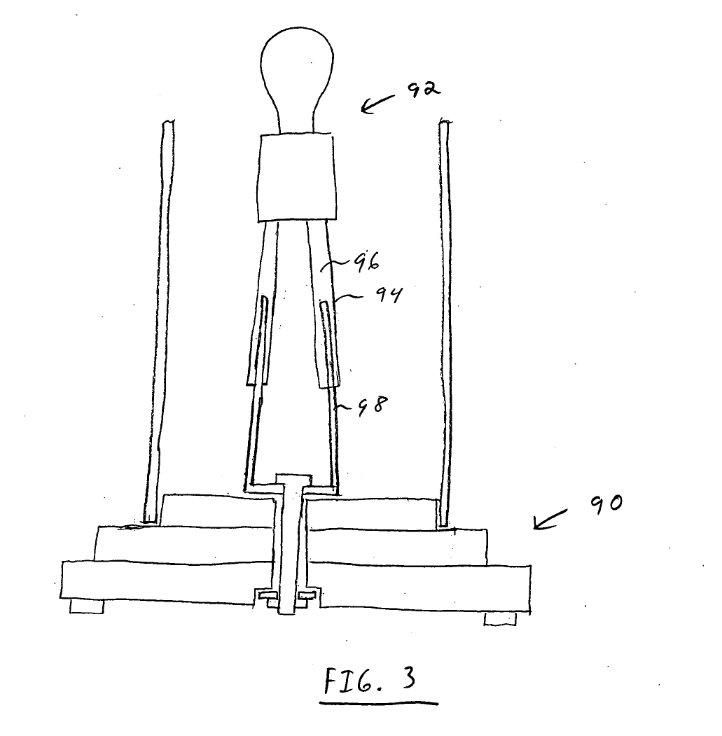

As shown in FIG. 1, the base may include a light source 20. The socket of the light source may be rigidly mounted to the base 18. FIG. 3 shows an alternative exemplary embodiment of a base 90, in which the light source 92 is mounted to a bracket 94. The bracket 94 is operative to adjustably place the light source at a plurality of different heights above the base 90. Depending on the picture being displayed, the light source can be lowered or raised to direct light through the image medium at an angle which best illuminates the features of the picture on the image medium.

In this described exemplary embodiment, the bracket is operative to telescopically increase and decrease in height. At each of a plurality of extensions the bracket is operative to support the weight of the light source such that the light source will remain stationary at the selected position. The bracket may include at least one upper leg 96 which is operative to cooperatively engage with at least one lower leg 98 such that the upper leg 96 or the lower leg 98 is operative to slide within or relative to the other of the upper leg 96 or the lower leg 98.

In the exemplary embodiment of the bracket shown in FIG. 3, the bracket may include two lower legs 98 which are urged inwardly in response to being engaged with two upper legs 96. In this relationship the lower legs are “spring loaded” and are operative to apply sufficient frictional resistence to movement to the upper legs to prevent the weight of the light source 92 from causing the upper legs 96 to slide down the lower legs 98.

In other exemplary embodiments, the device may include other bracketry that is operative to enable the height of the light source to be adjustable. For example, in an alternative exemplary embodiment, the bracketry may include a threaded portion that is operative to increase or decrease in height by screwing into or out of other threaded portions of the bracket. In further exemplary embodiments, the light source may have sufficient length to span the majority of the distance between the base and the cover of the device. An example of such a light source may include a light source with a fluorescent bulb which is elongated in height with respect to its width.

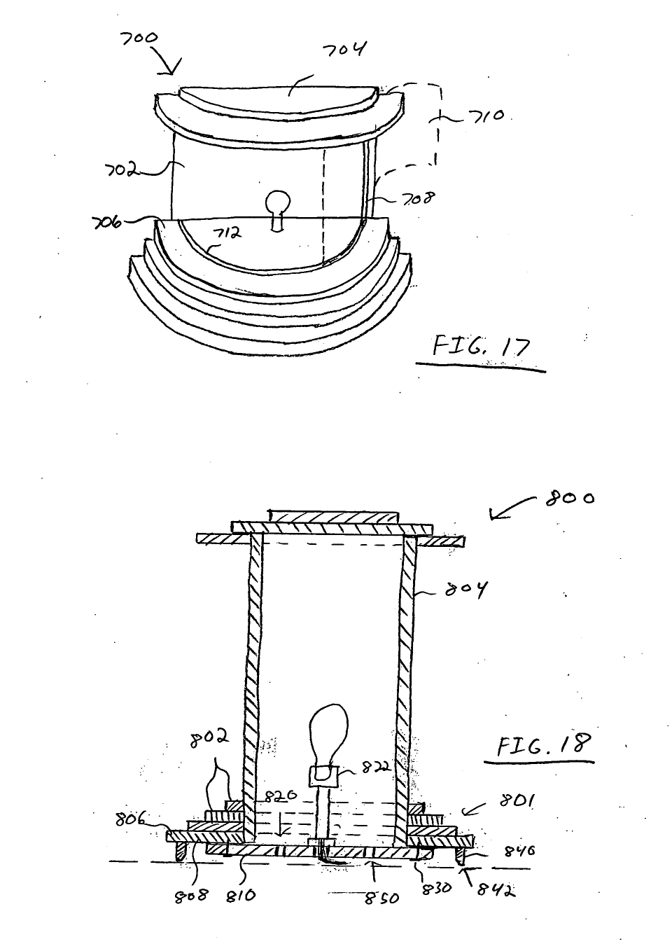

FIG. 18 shows cross-sectional view of an alternative exemplary embodiment of an image display device 800. Here the base 801 is comprised of a plurality of platters 802 in the form of rings. The rings include circular apertures therethrough which have a sufficient size to receive the cylindrical transparent tube 804 therethrough. In an exemplary embodiment, the one or more of the rings may be individually removed or added to the stack of rings by sliding off/on the tube. As a result different colored or different contoured rings may be swapped out with existing rings to provide the base with a different look.

In this described exemplary embodiment, the base may include a bottom platter 806 comprised of two members 808, 810. The first member 808 may correspond to a ring with an aperture 820. The aperture may have a diameter that about corresponds to the outer diameter of the tube 804. However, it is to be understood that apertures may be formed with different sizes to provide for different amounts of space between the tube and the bottom ring when the tube is inserted though the bottom ring.

The second member 810 is connected to the bottom of the first member 808 and is operative to at least partially span the aperture 820 of the second member. The second member may be removably mounted to the first member with fasteners 830 such as screws for example. The light source 822 and associated bracketry may be directly mounted to the second member 810.

In this described exemplary embodiment, the base may include three or more legs 840 which project downwardly from the first member 808. The length of the legs is longer than the thickness of the second member 810. As a result when placed on a generally planar surface, there is an air gap between the second member 810 and the surface. In an exemplary embodiment, the second member 810 may be comprised of a transparent material such as acrylic and may be operative to enable light from the light source to illuminate the surface below the image display device. In addition, the second member 810 may include one or more vent holes 850.

In this described exemplary embodiment the legs 840 of the image display device may correspond to cylinders made from a plastic for example. Also the tip of the legs may be tapered to form a bottom surface 842 which is narrower in at least one dimension compared to the diameter of the leg adjacent the second member 810.

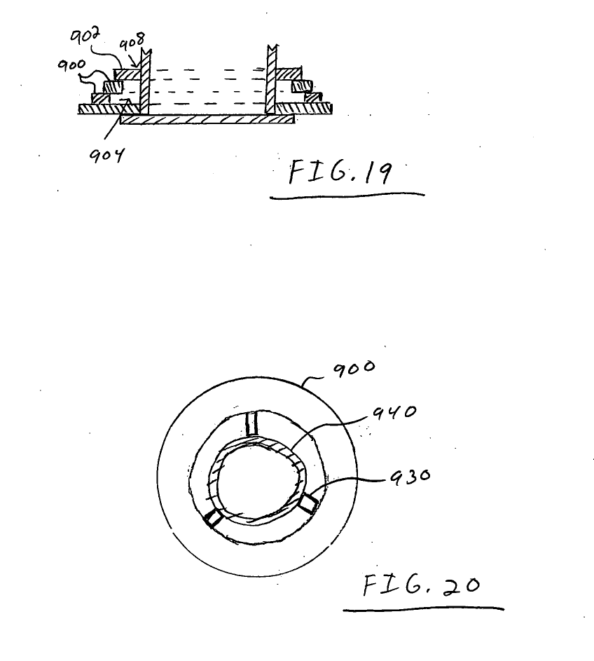

In exemplary embodiments, to make the image device lighter and/or to avoid using unneeded amounts of material to form the rings, ring material which is not visible may be removed from the rings. For example as shown in FIG. 19, at least one of the middle rings 900 below the top most ring 902 may include an aperture 904 with a diameter larger than the diameter 908 of the aperture of the top most ring. Further the diameter of the aperture 904 of the at least one of the middle rings 900 below the top most ring 902 may be smaller than the outer diameter of the ring immediately above it.

To prevent these middle rings 900 from sliding out of axial alignment with the other rings in the stack, these described middle rings 900 may include spokes. FIG. 20, shows an example of a ring 900 which includes three spokes 940 which extend between the inner surface of the ring 900 and the outer wall of the tube 940.

In the previously described exemplary embodiments of the image display devices shown in FIGS. 18 and 19, the rings 802 may be individually removable by sliding the rings off of the tube. However, in alternative exemplary embodiments, the rings may be more permanently connected together with fasteners and/or an adhesive. Further in alternative exemplary embodiments, the tube 804 may be mounted to the base 801 with fasteners and/or an adhesive.

In addition exemplary embodiments may include further components in the base which are operative to shield wiring to the socket of the light source. Such shielding may take the form of a cylinder which includes a cavity for enclosing electrical connections, wires and other electronic components. Such shielding may be mounted to the top of the second member 810. Such a cylinder may include an opening through which the electrical chord for the device passes therethough. In an exemplary embodiment, a knot may be formed in the electrical chord which has a size that is greater than the opening in the cylinder through which the electrical chord passes. Such a knot may be operative to resist outwardly directed forces acting on the chord from pulling apart electrical connections between the internal end of the chord and the light source of the device.

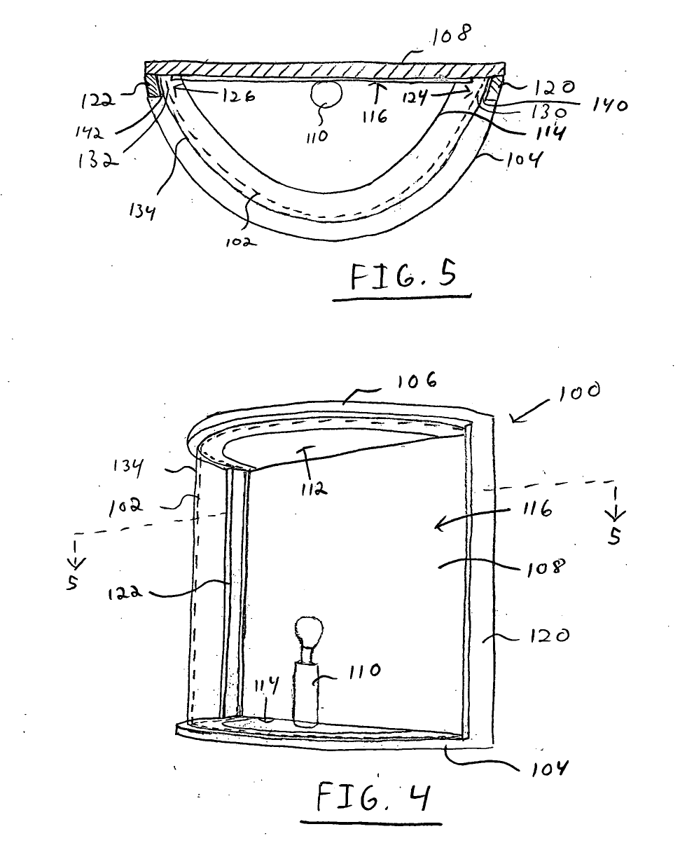

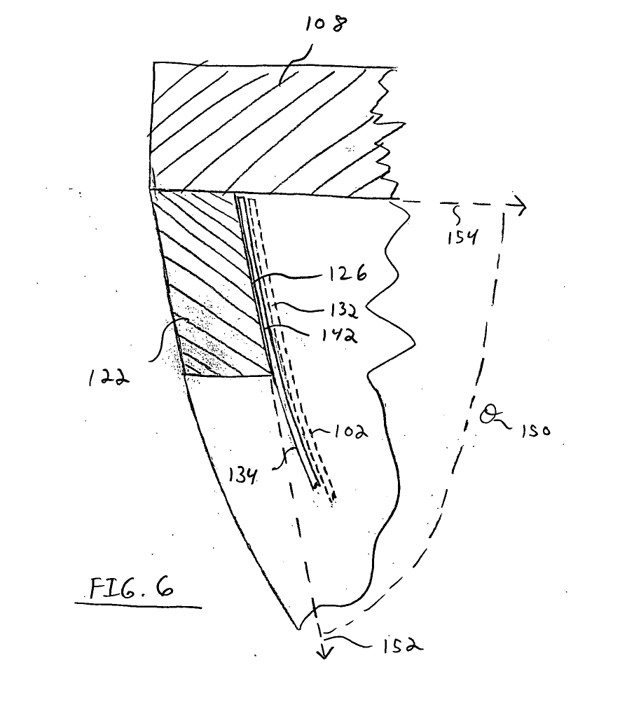

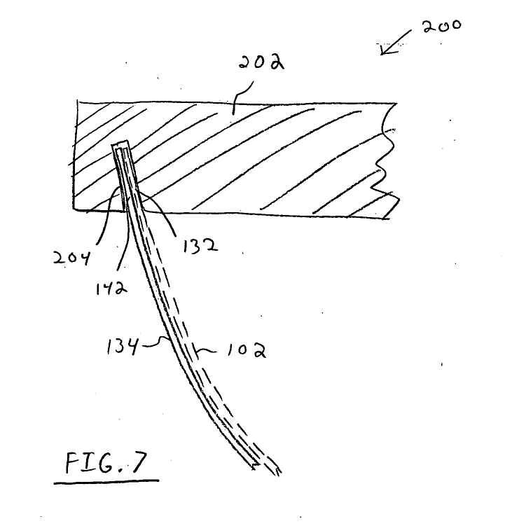

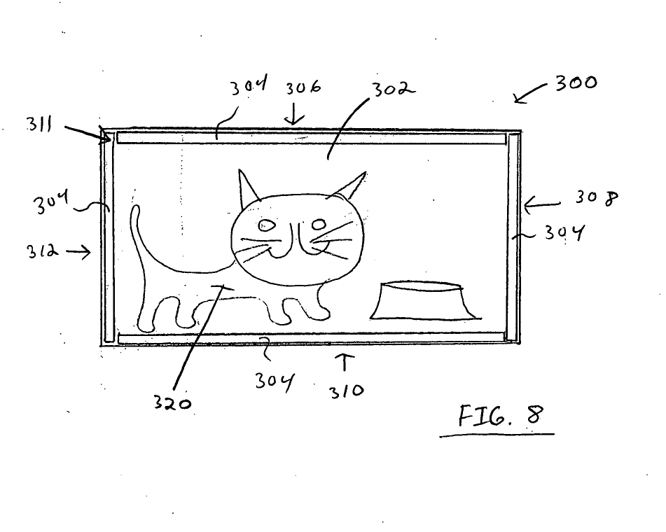

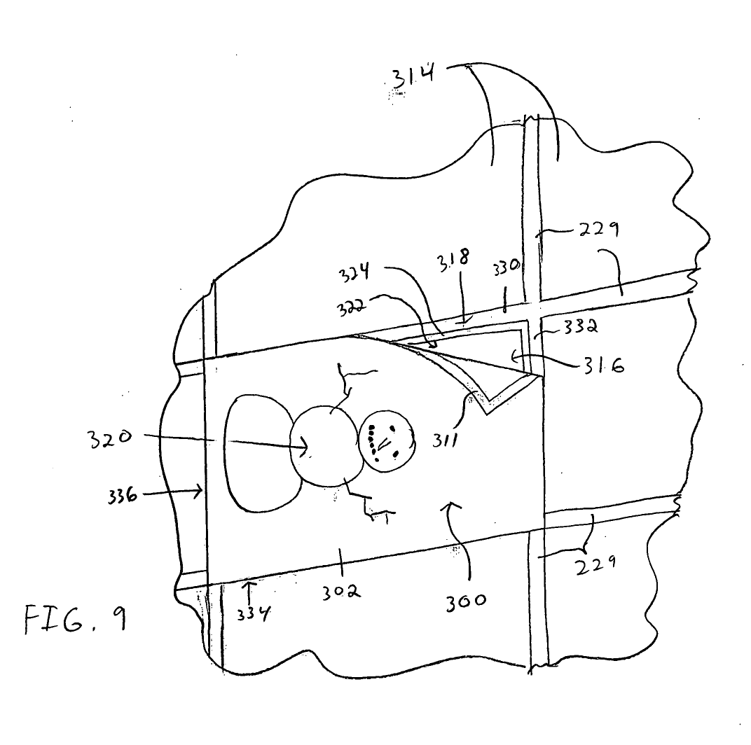

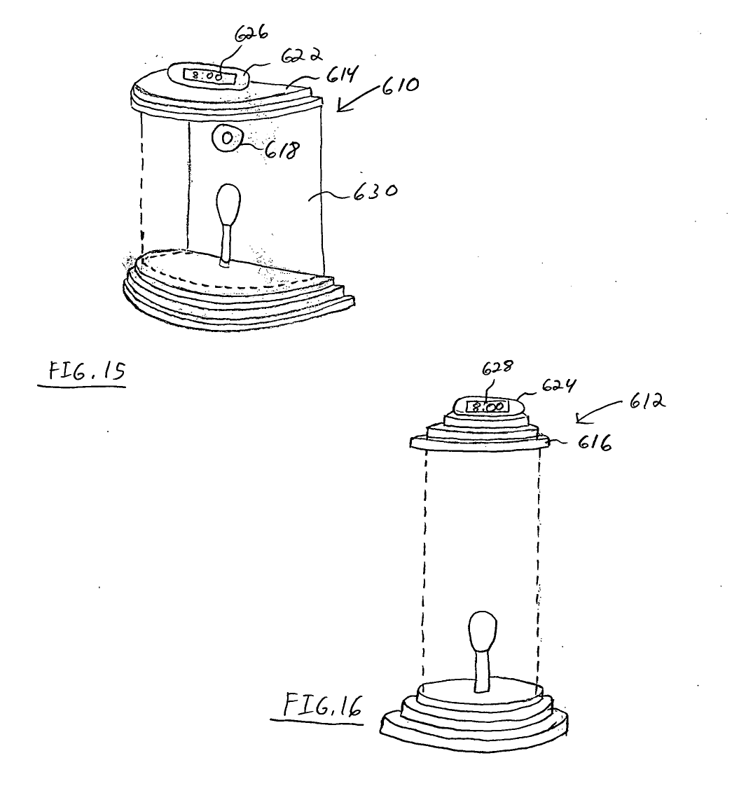

As shown in FIG. 4, an alternative exemplary embodiment 100 of the image display device may be operative to display an image medium 102 in an orientation in which the image medium is curled or bowed in a semicircle or other arc shape. As with the embodiment shown in FIG. 1, the display device may include both a base 104, a cover 106, and a light source 110. As shown in FIG. 17, this described embodiment of an image display device may also include a cover and/or base with a stepped contour as described previously with respect to the embodiment shown in FIG. 1.

In the described exemplary embodiment shown in FIG. 4, the image device may further include a back wall 108 that is operative to connect the cover 106 to the base 104. The cover, base and back wall may include reflective surfaces 112, 114, 116, integrated into or applied on the cover, base or back. For example, reflective sheets may be adhesively mounted to the cover, base and back wall. In the exemplary embodiment, the reflective surfaces 112, 114, 116 are operative to reflect light from the light source 110 toward the front of the device to transmit through the image medium 102.

As shown in FIG. 5, the back wall 108 may include two support members 120, 122 which extend toward the front of the device. Each support member 120, 122 may include an inner surface 124, 126. When an image medium is placed in the device in a curved orientation, the resilient qualities of the image medium may be operative to cause the side end portions 130, 132 of the image medium to apply outward pressure directed toward the inner surfaces 124, 126 of the support members 120, 122.

In this described exemplary embodiment, the device may further include a clear transparent member in the form of a flexible clear transparent sheet 134 which extends adjacent and in front of the image medium 102. Like the image medium, when the transparent sheet 134 is placed in the device in a curved orientation, the resilient qualities of the sheet may be operative to cause the side end portions 140, 142 of the transparent sheet to apply pressure directed toward the inner surfaces 124, 126 of the support members 120, 122. The flexible sheet may serve as a protective shield which minimizes damage to the image medium such as scratches, stains or other blemishes.

In this described exemplary embodiment the inner surfaces 124, 126 may not be parallel with each other but may extend from the back wall at inwardly directed angles. As shown in FIG. 6, an angle 150 between a plane 152 that includes the inner surface 126 and a plane 154 that transverses and extends between the support members 120, 122 may be less than 90 degrees and greater than 45 degrees. Likewise as shown in FIG. 5, the inner surface 124 of the support member 120 may have a corresponding oppositely orientated angle which is less than 90 degrees and greater than 45 degrees. In this described exemplary embodiment the inwardly directed angles of the inner surfaces and the outwardly directed pressures of the image medium 102 and transparent sheet 134 acting thereon are operative to lock the image medium 102 and transparent sheet 134 in the device. To remove the image medium 102, both the transparent sheet 134 and the image medium may be bended inwardly and then moved outwardly to disengage the transparent sheet 134 and the image medium 102 from the device.

FIG. 7 shows an alternative exemplary embodiment of the image display device 200. In this exemplary embodiment, the support members may correspond to spaced apart and angled vertical slots 204 in the back wall 202 of the device. The angled slots 204 may be operative to receive the side portions 132, 142 of the image medium and transparent sheet therein. Such slots in the back wall 202 may have the previously described inner surfaces therein. The angles of the inner surfaces of the slots may correspond to the previously described angles of the support member inner surfaces shown in FIG. 6 which range between 90 and 45 degrees. In exemplary embodiments the inner surfaces of the slots may be generally planar. In alternative exemplary embodiments the inner surfaces of the slots may be curved.

Referring back to FIG. 4, an exemplary embodiment of the device may include a cover 106 and base 104 that are permanently glued, fastened or formed integrally with the back wall 116. However, in an alternative exemplary embodiment, the cover and base may be in removable connection with the back wall. In an exemplary embodiment, the device may include releasable fasteners which enable the cover and/or base to be mounted and unmounted to the back wall hundreds of times without damaging the back wall, cover or base. In other exemplary embodiments, the back wall and cover may be operative to cooperatively engage with the back wall and the transparent sheet such that gravity, frictional forces, and interlocking members are operative to hold the device together without the use of separate fasteners.

In these described exemplary embodiments, when the cover, base, transparent sheet, image medium, and back wall are disassembled, the volume associated with these parts when stacked together for shipping is significantly smaller than the volume of the assembled image display device. As a result, the device may be readily shipped in a disassembled form between a plurality of different locations. At each destination the device may be reassembled and an image medium may be inserted into the device. Examples of such destinations may include trade shows, conventions, sales presentations, store displays, or any other locations which may require an illuminated image medium.

FIG. 17 shows an alternative exemplary embodiment of an image display device 700 in which the back wall 702, cover 704, and base 706 are rigidly mounted together with fasteners and/or an adhesive. In this described exemplary embodiment, the back wall may include a vertical slot 708 therethrough which is operative to receive the image medium and/or transparent medium 710. As the image medium and transparent medium is slid through the slot, horizontal grooves 712 in the base and cover are operative to guide and urge the image medium and/or transparent medium to curve back toward the back wall on the opposite end of the back wall from the slot.

In exemplary embodiments the image medium and the transparent medium may be inserted into and removed from the image display device by sliding through the slot 708. In an exemplary embodiment, to prevent the transparent medium from unnecessary sliding out of the track when the image medium is removed, the slot may include a projection which extends in the slot and is operative to block an edge of the transparent medium.

In further exemplary embodiments, the back wall may include a slot at each end of the back wall. Also in exemplary embodiments, the image display device may include separate slots and/or grooves for the image medium and the transparent medium.

Exemplary embodiments of the image display devices may range in size from table top units capable of displaying image mediums of several inches in height to floor models capable of displaying image mediums of several feet in height. In addition exemplary embodiments of the image display devices may have clear transparent mediums with curved surfaces such as the previously described tube 12 (FIG. 1) or transparent sheet 134 (FIG. 4) which have sizes and shapes which are operative to display image mediums with standard photography enlargement sizes such as 5×7 or 8×10 inches without requiring the image mediums to be cropped.

FIG. 8 shows a further exemplary embodiment of an image display device 300. Here the device includes a rectangular image medium 302. The image display device 300 further includes at least one flexible magnetic strip 304 adhesively mounted adjacent each of the four side edges 306, 308, 310, 312 of the image medium 302 to form a magnetic frame 311 adjacent the perimeter of the image medium. In an exemplary embodiment the device may include four individual magnetic strips mounted adjacent each of the edges of the image medium. In further exemplary embodiments a continuous magnetic strip may form a rectangular loop adhesively mounted to the image medium.

In the exemplary embodiment, the size and shape of the magnetic frame 311 corresponds to the size and shape of the rectangular support frames of a suspended ceiling grid which supportingly receives individual ceiling tiles or fluorescent ceiling light fixtures. FIG. 9 shows an example of the image display device 300 being mounted to the metallic runners 229 of a suspended ceiling grid 318. Such grids are typically used to support 2×4 feet ceiling tiles 314 and/or ceiling fluorescent light fixtures 316. In this described exemplary embodiment, the magnetic frame 311 of the display device 300 may have a size and shape which when placed against the ceiling is operative to magnetically adhere to the four portions 330, 332, 334, 336 of the runners 229 of the suspended ceiling grid 318 which bound the sides of the ceiling light fixture 316. When the light fixture is turned on, light from the fluorescent bulbs therein is operative to transmit through portions of the image medium 302 to illuminate a picture 320 on the image medium.

Standard fluorescent light fixtures often include a translucent diffuser cover 322. Such diffuser covers often include an opaque frame 324 which may be partially visible through the image medium and/or causes a shadow which is visible when looking at image medium 302. The exemplary embodiment of the display device is operative to minimize the visibility of the opaque frame 324 of the diffuser 322. In one exemplary embodiment the magnetic strips which form the magnetic frame 311 may have sufficient width to overlap both the runners 330, 332, 334, 336 of the suspended ceiling grid 318 and the inner opaque frame 324 of the diffuser. Such magnetic strips may be black and may be operative to form a solid black border around the perimeter of the image medium which conceals both the runners 330, 332, 334, 336 of the suspended ceiling grid 318 and the inner opaque frame 324.

As shown in FIG. 10, alternative exemplary embodiments of the display device may include an image medium 400 with a back and/or opaque border 402 developed or printed as part of the picture on the image medium 400. Such a black and/or opaque border may have a sufficient width to overlap both the runners 330, 332, 334, 336 of the suspended ceiling grid 318 and the frame 324 of the diffuser 322. The width of the strips that comprise the magnetic frame 404 may then have a relatively smaller width which corresponds to the width of the runners 330, 332, 334, 336 of the suspended ceiling grid 318.

In this described exemplary embodiment, the image display device for use with standard 2×4 feet suspended ceiling tiles and/or light fixtures may include an image medium of about 25 inches by 49 inches. The magnetic strips which comprise the magnetic border may have about a one inch width which corresponds to the one inch width of the runners 330, 332, 334, 336 of the suspended ceiling grid.

The black border developed or printed on the image medium may have a width of at least 1 and ⅞ inches to conceal both the runners of the suspended ceiling grid and the diffuser frame. However, it is to be understood that in alternative exemplary embodiments, the image display device may have other sizes for the image medium, magnetic frame, and a black border to correspond to other standard and non-standard implementations of suspended ceiling grids for supporting ceiling tiles and/or ceiling light fixtures.

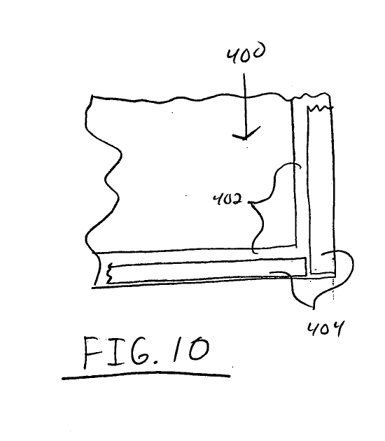

FIG. 11 shows an exemplary embodiment of a method for mounting the image display device 300 to a suspended ceiling grid 318. Here the method includes rolling the image display device 300 around a mounting device 410 such that a surface 412 of the image medium opposite the surface supporting the magnetic frame 311 contacts the mounting device 412. In this described exemplary embodiment the mounting device includes an elongated cylinder. Once rolled up, the portion of the magnetic frame 311 which remains uncovered may be aligned and magnetically adhered to one of the runners 336 of the suspended ceiling grid 318. The image display device may then be unrolled across the length of the light fixture 316 to place the magnetic frame 311 in overlapping registration with all four of the runners which bound the light fixture 316.

In this described exemplary embodiment, the mounting device 410 may correspond to a cardboard or plastic shipping tube which may have been used to ship the image display device. In other exemplary embodiments the mounting device may include other features which aid a user in mounting the image display device adjacent a ceiling light fixture. For example as shown in FIG. 12, a mounting device 500 may include a cylinder 502 in rotating connection with a handle 504. The image display device 300 may be rolled around the cylinder 502. In this described exemplary embodiment, a user may hold onto the handle 504 and pull or push the mounting device 500 so that the image display device 300 unrolls from the cylinder into magnetic engagement with the runners of the suspended ceiling grid.

Although the described exemplary embodiment of the image display device 300 for use with ceiling light fixtures has been shown with a magnetic frame, in other exemplary embodiments, other methods of attaching the image display device to a ceiling light fixture may be used. For example, in one exemplary embodiment, the diffuser from the ceiling light fixture may be replaced with a corresponding clear transparent sheet. In this exemplary embodiment the image medium may be placed on top of the clear transparent sheet when the clear transparent sheet is placed back into the light fixture. In other exemplary embodiments, a three-dimensional frame may be fastened to suspend beneath a light fixture. The three-dimensional frame may include three or more sides covered by clear transparent sheets. Each of the sides may be operative to support an image medium. When the fixture is turned on, the three or more image mediums may illuminate responsive to the light from the fixture passing therethrough.

Referring back to the cylindrical image display devices described with reference to FIG. 1, alternative exemplary embodiments may include multiple tubes of different sizes stacked on top of each other. For example, such image display devices may include a relatively larger diameter and shorter tube as a base with a relatively smaller diameter and longer tube positioned above the base tube. Each of the tubes may include an image medium therein. Such image display devices may include one or more light sources which are operative to illuminate the image mediums in one or more of the tubes.

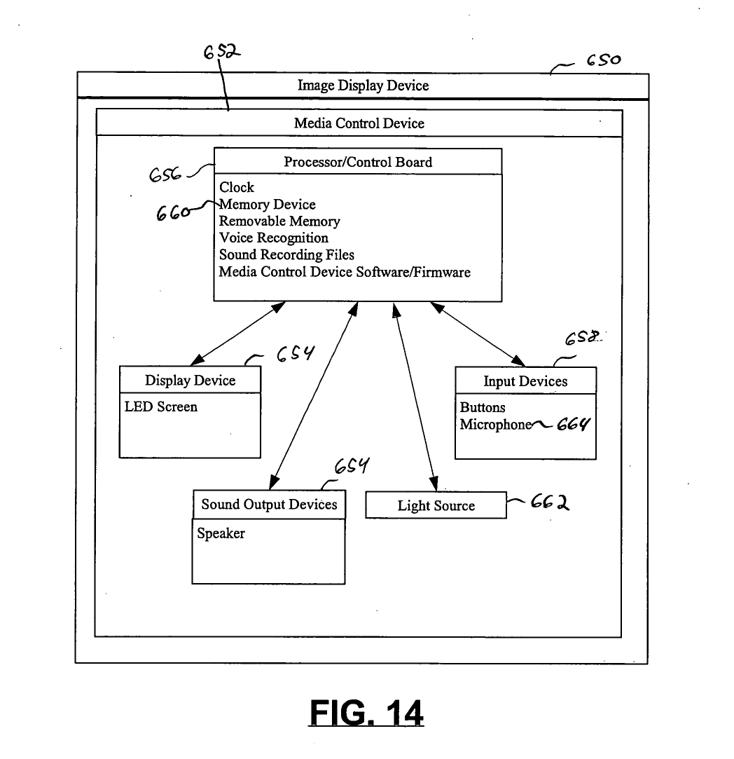

Further exemplary embodiments of the image display device may include a media control device referred to herein as a media device. FIGS. 15 and 16 show exemplary embodiments of image display devices 610, 612 which include a media device 622, 624 mounted to the cover 614, 616 of the image display devices. In this described exemplary embodiment the media device may include a clock, radio, alarm, music player, sound recording file player, and/or other features and components which are operative to provide visual and/or audio media to a user.

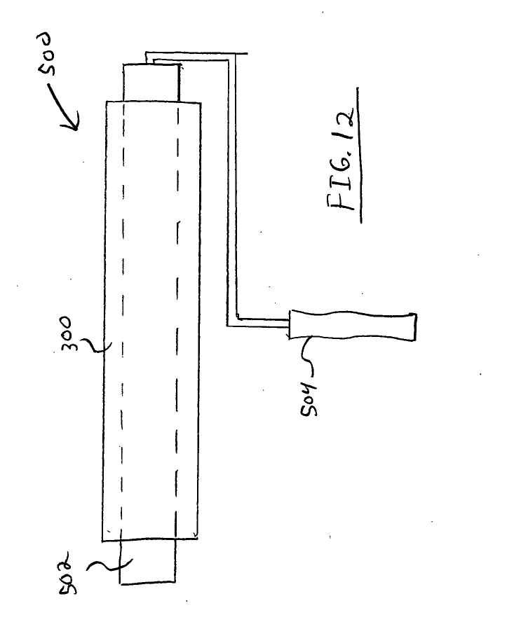

In exemplary embodiments, the media device may include a display device 626, 628 which is operative to output indicia representative of the current time. FIG. 14 shows a schematic view of an image display device 650 that includes a media device 652. The media device may be in operative connection with a sound output device 654. Such a sound output device may correspond to a speaker or other device that is operative to output an audible sound. As shown in FIG. 15 such a speaker 618 may be mounted in the interior of the image display device such as to the back wall 630 of the device shown in FIG. 15.

Referring back to FIG. 14, the media device may include a processor 656 and/or control circuitry which is operative to continuously output the current time through a display device 654. The processor 656 may also be operative to modify the current time displayed and perform other operations responsive to one or more input devices 658 such as buttons that are included with the media device. In an exemplary embodiment, the media device may include at least one memory device 660 which is operative to store information associated with one or more alarm times. When the current time outputted by the media device corresponds to an alarm time stored in the memory, the processor may be operative to cause the sound output device 654 to begin outputting a audible sound.

In further exemplary embodiments the memory may include stored therein, sound recording data. The processor may cause the sound output device 654 to output a sound signal which corresponds to the sound recording data. Such data may for example correspond to a sound recording file of a human voice which speaks a message. In exemplary embodiment, the media device may include a removable memory device such as a flash memory card or other portable memory device. The sound recording may be stored on the portable memory device in the form of a sound recording file such as an MP3, WAV, or other sound file format. In exemplary embodiments, the portable memory device of the media device may be replaced with a different portable memory device which includes a different sound recording.

In further exemplary embodiments, the media device may be in operative connection with the light source 662 of the image display device. The processor of the media device may be operative to turn on, turn off, brighten, dim and/or repeatedly flash the light source responsive to the alarm data or other data in the memory device. For example, rather than or in addition to causing a sound recording to be output through the sound output device, the processor may be operative to cause the light source to turn on or increase in brightness.

In further exemplary embodiments, the media device may include a microphone device 664 which is operative to detect spoken words or phrases. The processor may be operative to perform speech recognition and perform operations responsive to detected verbal commands. Such verbal commands may cause the media device to modify data stored in the memory device. For example, one or more verbal commands may be operative to cause the processor to: set the current time displayed on the display device; and set one or more alarm times stored in a memory of the media device. The verbal commands may also be operative to cause the processor to silence the sound output device for a predetermined amount of time (i.e. a snooze command) or until the current time again corresponds to alarm data stored in memory (i.e. alarm off command). The verbal commands may also be operative to cause the processor to silence the sound output device for a spoken amount of time. For Example, the phrase “Snooze for ten minutes” may be operative to cause the processor to temporarily silence the sound device and/or dim the light source for ten minutes.

Verbal commands may also be operative to cause the processor to change configuration settings for the media device which are stored in the memory. Such configuration settings may include what action the media device is to take to output an alarm. Such actions may include whether or not to output a sound recording message or other sound through the sound output device and whether or not to turn on the light source.

In further exemplary embodiments, the processor may include voice recognition programming which can be customized to only recognize verbal commands from a specific person. The processor may be operative to perform a training routine in which the processor outputs commands though the sound output device for the user to say specific phrase. Through use of the microphone the processor may be operative to record the verbal responses from the user to the memory device. After the training is complete, the processor is operative to compare verbal commands received through the microphone to the verbal responses stored in the memory. If a match is detected the processor is operative to perform the specific command or commands associated with the verbal response stored in the memory device.

In exemplary embodiments, a memory device may include a plurality of different sound recordings. The verbal commands may be operative to cause the processor to select one or more of the sound recordings for playing at times specified by the verbal commands. For example the verbal command phrase “Play track three now” may cause the media device to immediately begin playing a sound recording stored in memory which corresponds to a third one of a plurality of different sound recording stored in the memory of the device. The processor may also be operative to randomly or sequentially play different audio tracks each time an alarm is to be output though the sound output device. Further alternative exemplary embodiments, of the media device may be operative to wirelessly or though a wired connection communicate with a computer, CD player, TV, tap deck or other component to download a new sound recording file to the memory of the media device.

In addition, in exemplary embodiments, the memory device may include sound recordings associated with a particular subject matter. Also, physical objects associated with the subject matter of the sound recordings may be mounted to the cover or base of the image display device. For example, sound recordings may correspond to sounds or phrases associated with car racing. Objects associated with car racing may be mounted to the image display device. In this described exemplary embodiment, sound recordings associated with racing may include phrases such as: “Time to start your engine” and “get your wheels rolling and hit the pavement at full speed.” Examples of objects mounted to the image display device may include, a spark plug, wheel lug nut, chrome plated pulley, steering wheel, model racing car, trophy, or other objects associated with racing cars or other subject matter. In addition, the image display device may be provided with one or more image mediums with images associated with the subject matter of the messages. For example, for racing car subject matter, the image medium may include images of cars and/or race car drivers.

In exemplary embodiments of the media device, the processor may also be operative to record a persons' voice through use of the microphone. For example, the processor may record a message, phrase or singe word, and store the recording in the memory for later output through the sound output device. In addition, the media device may be operative to store a sound recording of a person's name. In, exemplary embodiments, the processor may be operative to cause the recorded person's name to be outputted through the sound output device along with other phrases stored in the memory. For example, if the sound recording of the person's name is “Jennifer”, the processor may concatenate a sound recording of the person's name with another stored sound recording to form the phrases: “Jennifer, time to start your engines” or “Jennifer, get your wheels rolling and hit the pavement at full speed.”

In further exemplary embodiments the memory device may include sound recordings of phrases spoken by famous persons associated with the subject matter of the messages. For example, if the subject matter of the sound recording message corresponds to race cars, the sound recordings may be phrases spoken by famous race car drivers. Further the image medium provided with the image display device may include an image of the famous person.

In further exemplary embodiments, sound recordings may correspond to music. In further exemplary embodiments, the sound recordings may include non-human sounds such as the sound of an engine starting, and revving up. Also a sound recording may be of a car racing several times around a track, each time with a higher volume.

In exemplary embodiments, in which the sound recording stored in the memory may be updated or replaced, exemplary embodiments may include a method of periodically sending updated sound recordings for use with the media device. Such new image sound recordings may be sent through the mail on a portable memory device which is capable of being accessed by the media device, In addition to sound recordings, new image medium may also be periodically sent to the owner of the image display device. In this described exemplary embodiment, an owner may subscribe to a program which offers updated sound recordings and/or image medium on a monthly or other periodic time basis.

In further exemplary embodiments, the owner of the lamp may order for a fee updated sound recordings and image mediums though use of an Internet web site. The web site may be operative to provide a user with the ability to select from a plurality of different sets of sound recordings and image mediums for use with the image display device. Such sound records may be downloaded using a computer for a fee and saved to a portable memory device of the media device. Ordered sound recordings and/or image mediums may also be sent to the user through the mail. In further exemplary embodiments, the sound recordings and/or images may be downloaded through the Internet. The downloaded sound recordings may be copied to the memory of the media device through a wired or wireless connection. Image files downloaded from the Internet may be printed out on appropriate transparency media with a user's printer.

In further exemplary embodiments, the processor may be responsive to a fire alarm, bugler alarm, whether radio alarm or other predetermined sound detected through the microphone to cause the sound output device to emit a repeating warning message in a human language which is representative of phrases such as “Fire Alarm”, “Burglar Alarm”, or other message which identifies the detected sound.

In the previously described exemplary embodiments, the light source and media device of the image display device may be provided power though an electrical line and plug adapted to be connected to a standard wall outlet. In further exemplary embodiments, the light source and/or media device may be powered through use of a battery that is charged using a photocell. Such a battery and photocell may be located externally from the image display device.

In further exemplary embodiments, the image display devices may be used to advertise products. For example, in a restaurant setting, a plurality of tables in the restaurant may include an image display device adjacent each table. Such an image display device may include an image medium depicting a dessert, beverage, or other product. In this described exemplary embodiment, each image display device may be coupled to a controller that is operative to individually illuminate each image display device at predetermined times. For example, during a customer's meal the controller may be operative to slowly illuminate the image display device so that after a predetermined amount of time after the customer is seated, the lamp will illuminate an image medium depicting a dessert. In further exemplary embodiments, the image display device may include a base that is operative to hold condiments.

In further exemplary embodiments, the image display device may be constructed for use outdoors. Such outdoor embodiments, may include gaskets which are operative to minimize water entering the image display device. In this described exemplary embodiment, the image display device may be mounted on a lamp post adjacent a driveway or serve as light fixtures adjacent doors for example. In further exemplary embodiments, the image display device may correspond to a nightlight adapted to mount directly to an electrical outlet.

In a further exemplary embodiment, an Internet web server may be provided which include web pages which enable a user to upload digital images to the web server. Such digital images may have been scanned by the user using a scanner or may have been taken by the user using a digital camera or video camera. Digital images uploaded to the web server may be reproduced on a transparency image medium by an digital photography entity associated with the web server and shipped via mail to the user for use in their image display device.

Thus the new image display device achieves one or more of the above stated objectives, eliminates difficulties encountered in the use of prior devices and systems, solves problems and attains the desirable results described herein.

In the foregoing description certain terms have been used for brevity, clarity and understanding, however no unnecessary limitations are to be implied therefrom because such terms are used for descriptive purposes and are intended to be broadly construed. Moreover, the descriptions and illustrations herein are by way of examples and the invention is not limited to the exact details shown and described.

In the following claims any feature described as a means for performing a function shall be construed as encompassing any means known to those skilled in the art to be capable of performing the recited function, and shall not be limited to the features and structures shown herein or mere equivalents thereof. The description of the exemplary embodiment included in the Abstract included herewith shall not be deemed to limit the invention to features described therein.

Having described the features, discoveries and principles of the invention, the manner in which it is constructed and operated, and the advantages and useful results attained; the new and useful structures, devices, elements, arrangements, parts, combinations, systems, equipment, operations, methods and relationships are set forth in the appended claims.

1. A method comprising:
a) providing at least one image medium, wherein the image medium includes at least one magnetic strip which extends in a loop about the perimeter of the image medium adjacent each edge of the image medium;
b) placing the image medium adjacent portions of runners of a suspended ceiling grid which form a rectangular opening beneath a ceiling light fixture; and
c) magnetically adhering the at least one magnetic strip to the portions of the runners, whereby light from the ceiling light fixture is operative to illuminate the image medium.

2. The method according to claim 1, wherein in step (b) the grid suspends a plurality of ceiling tiles.

3. The method according to claim 2, wherein in step (b) the ceiling tiles are about 2 feet by about 4 feet.

4. The method according to claim 2, wherein in step (a) the image media includes an generally opaque border formed on the image media adjacent each of the four edges of the image media, wherein the opaque border extends further inwardly than the at least one magnetic strip.

5. The method according to claim 4, wherein in step (a) the opaque border is at least about 1 inch in width.

6. The method according to claim 1, wherein in step (a) the width of the at least one magnetic strip about corresponds to the width of the runners.

7. The method according to claim 1, wherein in step (a) the width of the at least one magnetic strip is at least about one inch.

8. The method according to claim 1, wherein in step (a) the image medium is rolled up on a cylinder, wherein step (c) includes unrolling the image medium from the cylinder.
